(19) United States
(12) Patent Application Publication
(10) Pub. No.: US 2026/0026427 A1
(43) Pub. Date: Jan. 29, 2026

(54) DIRECT-INSERTION-TYPE MECHANIZED APPARATUS FOR UP-FILM TRANSPLANTING OF NAKED-SEEDLINGS AND METHOD THEREOF

(71) Applicant: SHANDONG ACADEMY OF AGRICULTURAL MACHINERY SCIENCES, Jinan (CN)

(72) Inventors: Hui LI, Jinan (CN); Tengfei HE, Jinan (CN); Hu LIU, Jinan (CN); Song SHI, Jinan (CN); Yupeng SHI, Jinan (CN)

(21) Appl. No.: 19/215,497

(22) Filed: May 22, 2025

(30) Foreign Application Priority Data
Jul. 25, 2024 (CN) 2024110079117

(51) Int. Cl. A01C 11/02

(52) U.S. Cl. CPC A01C 11/02

(57) ABSTRACT

The present invention discloses a direct-insertion-type mechanized apparatus for up-film transplanting of naked-seedlings and a method thereof, relating to the field of transplanting equipment, the apparatus comprises a seedling insertion assembly, wherein the seedling insertion assembly comprises a seedling inserter and a pull rod mechanism; the seedling inserter is connected to a driving assembly through the pull rod mechanism; a returning spring assembly is arranged between the driving assembly and the pull rod mechanism; and the driving assembly is used for enabling the seedling inserter to generate cyclic reciprocating planting actions along a single longitudinal plane so as to form boat-bottom-shaped posture-based naked-seedling transplanting. On the basis of that the posture of naked-seedlings meets the agronomic requirement after transplanting; the present invention solves problems of large film openings and poor soil backfilling effect.

### CROSS-REFERENCE TO RELATED APPLICATIONS

This invention claims priority benefits to Chinese patent application No. 202411007911.7, entitled “A Direct-insertion-type Mechanized Apparatus for Up-film Transplanting of Naked-seedlings and Method Thereof”, filed on Jul. 25, 2024, with the China National Intellectual Property Administration, the entire contents of which are incorporated herein by reference and form a part of the present invention for all purposes.

### TECHNICAL FIELD

The invention relates to the field of transplanting equipment, in particular to a direct-insertion-type mechanized apparatus for up-film transplanting of naked-seedlings and method thereof.

### BACKGROUND

Taking up-film transplanting of naked-seedlings of sweet potato as an example, at present, the up-film transplanting of sweet potato seedling has been gradually replaced by automatic or semi-automatic machinery from traditional manual complex operation, where types of these machinery mainly includes clamping type, chain clamp type and duckbill type. According to the particularity of principle of the mechanical transplanting apparatus and the complex agronomic requirements of sweet potato seedlings transplanting, when these three types of transplanting apparatuses are used in the transplanting, the sweet potato seedlings are needed to be picked up and placed by clamping seedlings mechanisms arranged at both sides of a planting apparatus of those transplanting apparatuses due to the particularity of their structure, which is easy to make the film opening too large. In addition, due to internal soil disturbances that may affect the posture of sweet potato seedlings after planting, and excessive movement of these mechanisms resulting in poor soil backfilling after planting, it is difficult to ensure the quality of sweet potato seedling planting by using transplanting apparatuses of clamping type, chain clamp type, and duckbill type structures during up-film transplanting.

### SUMMARY

Aiming at the defects existing in the prior art, an object of the present invention is to provide a direct-insertion-type mechanized apparatus for up-film transplanting of naked-seedlings and a method thereof, which solve the problems of large film openings and poor soil backfilling effect on the basis of meeting the agronomic requirements for the posture of naked-seedlings after transplanting.

In order to achieve the above object, the present invention is realized through the following technical solutions.

In a first aspect, an embodiment of the present invention provides a direct-insertion-type mechanized apparatus for up-film transplanting of naked-seedlings, comprising a seedling insertion assembly, wherein the seedling insertion assembly comprises a seedling inserter and a pull rod mechanism, the seedling inserter is connected to a driving assembly through the pull rod mechanism, and a returning spring assembly is mounted between the driving assembly and the pull rod mechanism; and
the driving assembly is configured for enabling the seedling inserter to generate cyclic reciprocating planting actions along a single longitudinal plane so as to form a boat-bottom-shaped posture-based naked-seedling transplanting.

As a further implementation mode, the seedling inserter comprises a main body of the seedling inserter and a fork part positioned at an end part of the main body of the seedling inserter, wherein the main body of the seedling inserter is of an arc shape.

As a further implementation mode, the pull rod mechanism comprises a pull rod and a diagonal pull rod, one end of each of the pull rod and the diagonal pull rod is detachably connected to the seedling inserter, another end of the pull rod is connected to the driving assembly, and another end of the diagonal pull rod is connected to a set position on the pull rod.

As a further implementation mode, the returning spring assembly comprises a fixed plate, wherein a sliding fitting part is provided on the fixed plate, and a sliding block is connected to the sliding fitting part in a sliding way; a first spring is connected between the sliding block and one end of the fixed plate, and a second spring is connected between the sliding block and the pull rod.

As a further implementation mode, a bearing is mounted at a fitting end of the sliding block and the sliding fitting part.

As a further implementation mode, the sliding fitting part is configured to have a set inclination angle with the vertical normal line.

As a further implementation mode, the driving assembly comprises a gear box and a transmission mechanism arranged in the gear box, and the transmission mechanism is connected to the pull rod mechanism.

As a further implementation mode, the transmission mechanism comprises a main shaft and a counter shaft, wherein a non-full-tooth driving gear is provided on the main shaft, a full-tooth driven gear is provided on the counter shaft, and the non-full-tooth driving gear is matched with the full-tooth driven gear; and, a chain wheel is provided on one end of the main shaft.

In a second aspect, an embodiment of the present invention further provide a direct-insertion-type mechanized up-film transplanting method of naked-seedlings, using a transplanting apparatus described above, wherein the transplanting method comprises:
a full-tooth driven gear is driven to rotate clockwise by the non-full-tooth driving gear rotating counter-clockwise, to drive a seedling inserter moving clockwise to insert a naked-seedling into soil; the transplanting apparatus completes one working cycle after the non-full-tooth driving gear rotates for one cycle; wherein, when gear teeth in the non-full-tooth driving gear are meshed with the full-teeth driven gear, the seedling inserter implements a clockwise transplanting action; and, when gear teeth in the non-full-tooth driving gear are not meshed with the full-tooth driven gear, the seedling inserter is pulled back to an original position by a returning spring assembly to complete the one working cycle.

The beneficial effects of the present invention are as follows:

According to the present invention, when transplanting seedlings into soil, the seedling inserter only moves on a single longitudinal plane without transverse movement, and during processes of inserting into the soil and out, only the seedling inserter, such a structurally narrow component, moves in the soil, i.e., a working space is relatively small in the transplanting process, so the apparatus has the advantages of small film breaking opening, small soil disturbance, good soil covering effect and the like in the working process; when the apparatus only performs transplanting action and does not move forward, an overall trajectory meets the agronomic requirements of “boat-bottom-shaped” posture of naked-seedling transplantation.

According to the present invention, a returning spring assembly is arranged between the seedling insertion assembly and the driving assembly, and a segmented spring design is adopted, so that the bad vibration of the spring during rebound can be reduced, and the stability of the movement of the apparatus on a single longitudinal plane can be enhanced. According to the present invention, power is transmitted to a non-full-tooth gear through a chain wheel; the seedling inserter is rigidly connected to a full-tooth gear and generates cyclic reciprocating planting action through the mutual motion action with the non-full-tooth gear. The apparatus has fewer parts and simple structure and working principle, so that it is not easy to damage in the working process and have good stability.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a structural diagram of a transplanting apparatus according to one or more examples of the present invention.

FIG. 2 is a structural diagram of a seedling insertion assembly according to one or more examples of the present invention.

FIG. 3 is a structural diagram of a returning spring assembly according to one or more examples of the present invention.

FIG. 4 is a structural diagram of a gear box according to one or more examples of the present invention.

FIG. 5 is a structural diagram of a transmission mechanism according to one or more examples of the present invention.

FIG. 6 is a schematic diagram of a working process according to one or more examples of the present invention.

Wherein: 1, seedling insertion assembly; 101, seedling inserter; 102, pull rod; 103, diagonal pull rod; 2, returning spring assembly; 201, fixed plate; 202, bearing; 203, first spring; 204, sliding block; 205, second spring; 206, fixed bolt; 207, sliding fitting part; 3, gear box; 301, box body; 302, end cover; 4, transmission mechanism; 401, chain wheel; 402, main shaft; 403, bearing; 404, counter shaft; 405, full-tooth driven gear; 406, non-full-tooth driving gear.

### DETAILED DESCRIPTION

### Example 1

In a typical example of the present invention, as shown in FIG. 1, a direct-insertion-type mechanized apparatus for up-film transplanting of naked-seedlings is provided.

In order to solve the problems of large film openings and poor soil backfilling effect on the basis of meeting the agronomic requirements of posture of naked-seedlings after transplanting, the present example provides a direct-insertion-type mechanized apparatus for up-film transplanting of naked-seedlings, which adopts a mechanized mode instead of manual labor to continuously plant naked-seedlings, so as to improve the transplanting quality of naked-seedlings.

Hereinafter, the direct-insertion-type mechanized apparatus for up-film transplanting of naked-seedlings will be described in detail with reference to the accompanying drawings.

As shown in FIG. 1, the direct-insertion-type mechanized apparatus for up-film transplanting of naked-seedlings comprises a seedling insertion assembly 1, a returning spring assembly 2 and a driving assembly, wherein the returning spring assembly 2 is connected between the seedling insertion assembly 1 and the driving assembly.

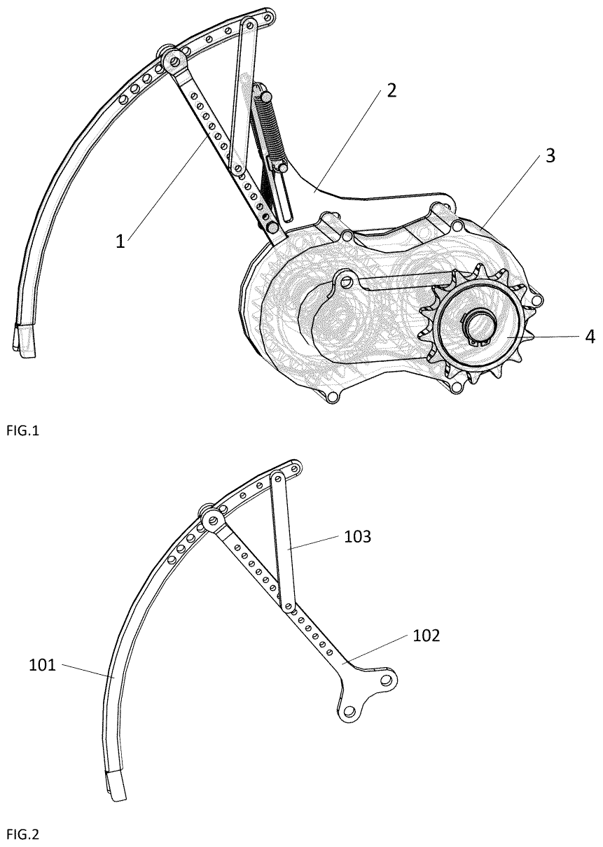

Specifically, as shown in FIG. 2, the seedling insertion assembly 1 comprises a seedling inserter 101 and a pull rod mechanism, wherein the pull rod mechanism comprises a pull rod 102 and a diagonal pull rod 103, and the seedling insertion assembly 1 can be made of by cutting from a steel plate.

The seedling inserter 101 comprises a main body of the seedling inserter and a fork part connected to one end of the main body of the seedling inserter, wherein the main body of the seedling inserter is of an arc shape so as to meet the agronomic requirement of “boat-bottom-shaped” posture of naked-seedling transplanting. In the present example, a moving trajectory of the seedling inserter 101 in the soil is an arc (a distance between a lowest point of the arc, i.e., the lowest point of the naked-seedling and a ground is 10±2 cm) with a diameter of one quarter (90°±5°) of side length of a circle. When the apparatus actually works on a transplanting machine, a transplanting trajectory of the seedling inserter 101 is a combination of the arc with the diameter of the one quarter of the side length of the circle and a linear movement, and the overall trajectory meets the agronomic requirements of the “boat-bottom-shaped” posture of the naked-seedlings transplantation.

A plurality of through holes are opened at one end of the main body of the seedling inserter where far away from the fork part, so as to provide different mounting positions of the pull rod 102 and the diagonal pull rod 103; and the pull rod 102 is also opened with a plurality of through holes along the length direction thereof. One end of the pull rod 102 is connected to a corresponding through hole on the main body of the seedling inserter, one end of the diagonal pull rod 103 is mounted close to another end of the main body of the seedling inserter, and another end of the diagonal pull rod 103 is connected to the through hole of a corresponding position on the pull rod 102.

By arranging the through holes on the main body of the seedling inserter and the pull rod 102, the connection positions of the corresponding parts can be changed, so as to realize different planting trajectories and planting depths of naked-seedlings; the through holes on the pull rod 102 also provide different mounting points for fixing bolts 206 in the returning spring assembly 2.

In the present example, the connecting modes of the pull rod 102, the diagonal pull rod 103 and the main body of the seedling inserter, and the connecting modes of the pull rod 102 and the diagonal pull rod 103 are all pin shaft connection and cotter pin locking modes.

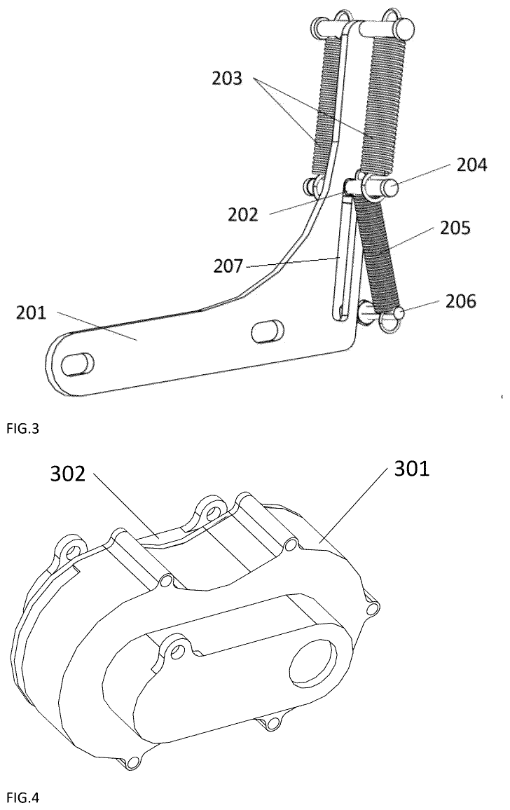

As shown in FIG. 3, the returning spring assembly 2 comprises a fixing plate 201, a sliding block 204, a sliding fitting part 207, a spring, etc.; wherein, the fixing plate 201 is detachably connected to an end cover 302 of the gear box 3, and the fixing plate 201 is positioned at a rear side of the seedling inserter 101 with a working end of the seedling inserter 101 as a front side.

In order to make the structure compact and simultaneously perform the connection function, in the present example, the fixing plate 201 is provided in an L shape. The fixed plate 201 is provided with the sliding fitting part 207, and the sliding fitting part 207 is slidably connected to the sliding block 204, i.e., the sliding block 204 can move relative to the sliding fitting part 207. In the present example, the sliding fitting part 207 may be a guide rail or a sliding groove as long as a movement requirement of the sliding block 204 can be satisfied.

Since the returning spring assembly 2 can reset the seedling inserter 101, in order to effectively reduce the undesirable vibration of the spring during rebound, a segmented spring is introduced, wherein a first fixing point of the segmented spring is the top end of the fixing plate 201, a second fixing point is at one end of the pull rod 102 close to the gear box 3, and a fixing bolt 206 is mounted on the second fixing point; and the mounting position of the fixing bolt 206 can be adjusted according to requirements during actual operation.

Specifically, a first spring 203 is connected between the sliding block 204 and the top end of the fixing plate 201, and a second spring 205 is connected between the sliding block 204 and the fixing bolt 206. The first spring 203 and the second spring 205 form the segmented spring. Two first springs 203 are respectively arranged on two sides of the fixing plate 201, that is, the first springs 203 are symmetrically arranged with respect to the fixing plate 201, and at least one second spring 205 is arranged on one side of the fixing plate 201 to meet the reset requirement. In the present example, the second spring 205 is provided on one side, which satisfies the reset requirement. It can be understood that in other examples, the second spring 205 can also be provided on both sides of the fixing plate 201.

The sliding fitting part 207 is configured to be inclined and form an acute angle with the vertical normal line, so that the spring can avoid interference with the gear box 3 when in operation. In the present example, the angle between the sliding fitting part 207 and the vertical normal line is 10°±5°.

A bearing 202 is mounted at the fitting end of the sliding block 204 and the sliding fitting part 207, so that the response of the returning spring can be timelier during the operation.

The driving assembly comprises the gear box 3 and a transmission mechanism 4 installed inside the gear box 3, as shown in FIG. 4, the gear box 3 comprises a box body 301 and the end cover 302 mounted outside the box body 301. The gear box 3 is used for providing mounting positions for other components of the transplanting apparatus. In addition, a plurality of bolt mounting fixing points is arranged outside the gear box 3, so that the transplanting apparatus can be conveniently mounted on a transplanting machine or other machines.

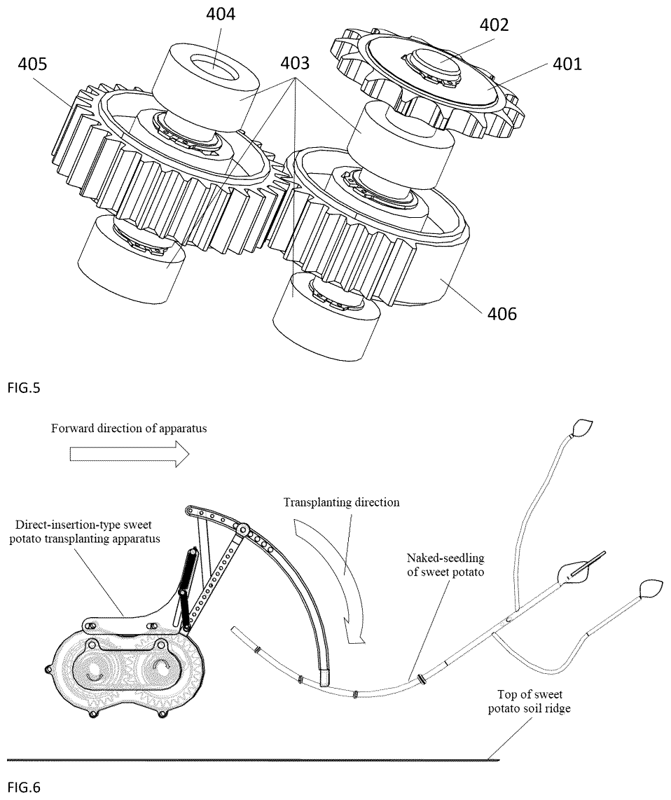

As shown in FIG. 5, the transmission mechanism 4 comprises a main shaft 402, a counter shaft 404, a non-full-tooth driving gear 406, a full-tooth driven gear 405, etc.; wherein, the non-full-tooth driving gear 406 is mounted on the main shaft 402, the full-tooth driven gear 405 is mounted on the counter shaft 404, and the full-tooth driven gear 405 can mesh with the gear teeth in the non-full-tooth driving gear 406.

One end of the main shaft 402 is provided with a chain wheel 401, the counter shaft 404 is connected to the pull rod mechanism, the whole transmission mechanism 4 is fixed into the gear box 3 by four bearings 403, an external machinery transmits the rotation motion to the chain wheel 401 through chain transmission, and a power transmission route is: (sequentially) the chain wheel 401→the main shaft 402→the non-full-tooth driving gear 406→the full-tooth driven gear 405→the seedling insertion assembly 1.

Due to the special structural design of the apparatus in the present example, compared with other types of transplanting apparatuses such as clamping type ones and chain clamping type ones, the seedling inserter 101 of the present apparatus only moves on a single longitudinal plane without transverse movement when it performs transplantation into the soil, and only the seedling inserter, which has a narrow structure, moves in soil when it moves into the soil and out, that is, the working space is relatively small during the transplanting process, so the apparatus has the advantages of small film breaking opening, small soil disturbance, good soil covering effect and the like during the working process.

When the apparatus only carries out transplanting actions and does not move forward, the trajectory of the seedling inserter 101 moving in the soil is an arc (a distance between a lowest point of the arc, i.e., the lowest point of the naked-seedlings and the ground is 10±2 cm) with a side length of one quarter (90°±5°) of a circle with a diameter of 400 mm (the diameter can be selected according to actual requirements); when the apparatus actually works on the transplanting machine, the transplanting trajectory of the seedling inserter is a combination of the arc with the side length of one quarter of the circle with the diameter of 400 mm and a linear movement, and the overall trajectory meets the agronomic requirements of “boat-bottom-shaped” posture of the naked-seedling transplanting.

Taking sweet potato up-film transplanting as an example, during operation, the transplanting apparatus of the present example is mounted and fixed behind the naked-seedling conveying assembly of the transplanting machine, the seedling inserter 101 is placed above sweet potato seedlings in a seedling placing plate, the whole transplanting apparatus and the naked-seedling conveying assembly are placed on the ridge, and the transplanting machine inputs power to the chain wheel outside the transplanting apparatus in a chain sprocket mode; after adjusting the posture of the transplanting apparatus, the whole machine starts to work, and the apparatus can effectively realize the “boat-bottom-shaped” posture of the sweet potato seedlings in the soil, so as to meet the complex planting agronomic requirements of the sweet potato seedlings.

### Example 2

The present example provides a direct-insertion-type mechanized up-film transplanting method of naked-seedlings, using the transplanting apparatus described in Example 1, comprising:
when a transplanting apparatus is in operation, the transplanting apparatus is mounted and fixed on a transplanting machine, as shown in FIG. 6, the transplanting machine transmits power to a chain wheel 401 through chain transmission, the chain wheel 401 transmits the power to a non-full-tooth driving gear 406 through a main shaft 402, the non-full-tooth driving gear 406 is meshed with a full-tooth driven gear 405, and a seedling insertion assembly 1 is rigidly connected to the full-tooth driven gear 405. The non-full-tooth driving gear 406 rotates counter clockwise to drive the full-tooth driven gear 405 to rotate clockwise, thereby driving a seedling inserter 101 to insert naked-seedlings into the soil in a clockwise direction; and
when the non-full-tooth driving gear 406 rotates for one cycle, the transplanting apparatus completes a working cycle, i.e. transplanting one the naked-seedling; when gear teeth in the non-full-tooth driving gear 406 mesh with the full-tooth driven gear 405, the seedling inserter 101 performs a clockwise transplanting action; when gear teeth in the non-full-tooth driving gear 406 are not meshed with the full-tooth driven gear 405, the seedling insert assembly 1 is pulled back to an original position by a returning spring assembly 2 to complete the working cycle; and then, the plug assembly 1 and the full-tooth driven gear 405, at the present original position, wait for the next meshing, i.e., the next working cycle.

The foregoing descriptions are merely preferred embodiments of the present invention but are not intended to limit the present invention. A person skilled in art may make various alterations and variations to the present invention. Any modification, equivalent replacement, or improvement made within the spirit and principle of the present invention shall fall within the protection scope of the present invention.

1. A direct-insertion-type mechanized apparatus for up-film transplanting of naked-seedlings, comprising a seedling insertion assembly, wherein the seedling insertion assembly comprises a seedling inserter and a pull rod mechanism, the seedling inserter is connected to a driving assembly through the pull rod mechanism, and a returning spring assembly is mounted between the driving assembly and the pull rod mechanism; and
the driving assembly is configured for enabling the seedling inserter to generate cyclic reciprocating planting actions along a single longitudinal plane so as to form a boat-bottom-shaped posture-based naked-seedling transplanting.

2. The direct-insertion-type mechanized apparatus for up-film transplanting of naked-seedlings according to claim 1, wherein the seedling inserter comprises a main body of the seedling inserter and a fork part positioned at an end part of the main body of the seedling inserter, wherein the main body of the seedling inserter is of an arc shape.

3. The direct-insertion-type mechanized apparatus for up-film transplanting of naked-seedlings according to claim 1, wherein the pull rod mechanism comprises a pull rod and a diagonal pull rod, one end of each of the pull rod and the diagonal pull rod is detachably connected to the seedling inserter, another end of the pull rod is connected to the driving assembly, and another end of the diagonal pull rod is connected to a set position on the pull rod.

4. The direct-insertion-type mechanized apparatus for up-film transplanting of naked-seedlings according to claim 1, wherein the returning spring assembly comprises a fixed plate, wherein a sliding fitting part is provided on the fixed plate, and a sliding block is connected to the sliding fitting part in a sliding way; a first spring is connected between the sliding block and one end of the fixed plate, and a second spring is connected between the sliding block and the pull rod.

5. The direct-insertion-type mechanized apparatus for up-film transplanting of naked-seedlings according to claim 4, wherein a bearing is mounted at a fitting end of the sliding block and the sliding fitting part.

6. The direct-insertion-type mechanized apparatus for up-film transplanting of naked-seedlings according to claim 4, wherein the sliding fitting part is configured to have a set inclination angle with the vertical normal line.

7. The direct-insertion-type mechanized apparatus for up-film transplanting of naked-seedlings according to claim 1, wherein the driving assembly comprises a gear box and a transmission mechanism arranged in the gear box, and the transmission mechanism is connected to the pull rod mechanism.

8. The direct-insertion-type mechanized apparatus for up-film transplanting of naked-seedlings according to claim 7, wherein the transmission mechanism comprises a main shaft and a counter shaft, wherein a non-full-tooth driving gear is provided on the main shaft, a full-tooth driven gear is provided on the counter shaft, and the non-full-tooth driving gear is matched with the full-tooth driven gear; and, a chain wheel is provided on one end of the main shaft.

9. A direct-insertion-type mechanized up-film transplanting method of naked-seedlings, using a transplanting apparatus according to claim 8, and comprising:
driving the full-tooth driven gear to rotate clockwise by the non-full-tooth driving gear rotating counter-clockwise, to drive the seedling inserter moving clockwise to insert a naked-seedling into soil; one working cycle is completed by the transplanting apparatus after the non-full-tooth driving gear rotates for one cycle; wherein, when gear teeth in the non-full-tooth driving gear are meshed with the full-teeth driven gear, a clockwise transplanting action is carried out by the seedling inserter; and, when gear teeth in the non-full-tooth driving gear are not meshed with the full-tooth driven gear, pulling, by the returning spring assembly, the seedling inserter back to an original position, to complete the one working cycle.

10. The direct-insertion-type mechanized apparatus for up-film transplanting of naked-seedlings according to claim 2, wherein the pull rod mechanism comprises a pull rod and a diagonal pull rod, one end of each of the pull rod and the diagonal pull rod is detachably connected to the seedling inserter, another end of the pull rod is connected to the driving assembly, and another end of the diagonal pull rod is connected to a set position on the pull rod.

11. The direct-insertion-type mechanized apparatus for up-film transplanting of naked-seedlings according to claim 5, wherein the sliding fitting part is configured to have a set inclination angle with the vertical normal line.
